(19) United States
(12) Patent Application Publication
(10) Pub. No.: US 2026/0067298 A1
(43) Pub. Date: Mar. 5, 2026

(54) SYSTEMS AND METHODS FOR BOT IDENTIFICATION AND PROTECTION

(71) Applicant: JPMORGAN CHASE BANK, N.A., New York, NY (US)

(72) Inventors: Surendra MOHAN, Melissa, TX (US); Rahul RAJENDRAN, Plano, TX (US); Ravikumar R, Bengaluru (IN); Subash Kumar USHA, McKinney, TX (US); Raghavendra BOYA, Bengaluru (IN); Hari UTTERPALLY, Sangareddy (IN); Suresh MADHAVAN, New York, NY (US)

(21) Appl. No.: 18/929,116

(22) Filed: Oct. 28, 2024

(30) Foreign Application Priority Data
Sep. 4, 2024 (IN) 202411066887

(51) Int. Cl. H04L 9/40

(52) U.S. Cl. CPC H04L 63/1416

(57) ABSTRACT

Methods and systems consistent with the disclosure can include receiving, from a web browser executed on a consumer electronic device and by a server executing an application, a request to perform a threat analysis of an access attempt; collecting, through a signal collector of the application, a signal from a browser, a signal from the consumer electronic device, a signal from a network, and an interaction signal; aggregating, through an aggregator of the application, the collected signals into a database, parsing, through a parser of the application, the collected signals; generating, through a signature generator of the application, a behavior signature from the collected signals; analyzing, through an analyzer of the application, the behavior signature; determining, through the analyzer of the application, whether the access attempt is malicious; and implementing, through a responder of the application, a security response on the web browser based on the access attempt being malicious.

### BACKGROUND OF THE INVENTION

### 1. Field of the Invention

Embodiments relate generally to internet connected device identity and security.

### 2. Description of the Related Art

Studies show over 60% of internet traffic is automated and a substantial amount of that automated traffic is malicious in nature. That number is likely to increase due to the rise of machine learning models and large language models. Current identity and security systems require an elaborate application spanning multiple layers through a frontend and a backend, and include manual controls. This requires extensive data transfer throughout a network, taking significant manual hours and requiring significant network resources such as memory and bandwidth. Additionally, conventional systems are imperfect and allow bot access, scraping, and in some cases credential theft, session hijacking, spamming, account takeovers, or otherwise taking up valuable resources and even resulting in denial-of-service. As such, there is a need for a novel way to operate identity and security systems in an efficient, automated way. Further, there is a need to be able to combat the increasing complexity of bots and denial-of-service attacks.

### SUMMARY OF THE INVENTION

Methods and systems consistent with the disclosure can include receiving, from a web browser executed on a consumer electronic device and by a server executing an application, a request to perform a threat analysis of an access attempt; collecting, through a signal collector of the application, a signal from a browser, a signal from the consumer electronic device, a signal from a network, and an interaction signal; aggregating, through an aggregator of the application, the collected signals into a database, parsing, through a parser of the application, the collected signals; generating, through a signature generator of the application, a behavior signature from the collected signals; analyzing, through an analyzer of the application, the behavior signature; determining, through the analyzer of the application, whether the access attempt is malicious; and implementing, through a responder of the application, a security response on the web browser based on the access attempt being malicious.

Embodiments consistent with the present disclosure include a method for internet connected device identity and security, comprising: receiving, from a web browser executed on a consumer electronic device and by a server executing an application, a request to perform a threat analysis of an access attempt; collecting, through a signal collector of the application, a signal from a browser, a signal from the consumer electronic device, a signal from a network, and an interaction signal; aggregating, through an aggregator of the application, the collected signals into a database, parsing, through a parser of the application, the collected signals; generating, through a signature generator of the application, a behavior signature from the collected signals; analyzing, through an analyzer of the application, the behavior signature; determining, through the analyzer of the application, whether the access attempt is malicious based on the analysis; and implementing, through a responder of the application, a security response on the web browser based on the access attempt being determined as malicious.

According to some embodiments, analyzing can further comprise generating a risk score and comparing the risk score to a threshold. According to some embodiments, the analyzer can implement a machine learning program to determine the risk score based on a database of previous access attempts.

According to some embodiments, the interaction signal can comprise one or more of a mouse movement, a keyboard movement, a scroll, and a field entry. According to some embodiments, the network signal can comprise one or more of a browser header, a network property, and a network time offset. According to some embodiments, the device signal can comprise one or more of a pixel depth, a screen size, a color support, a processer property, a time zone, a graphic rendering application programming interface, and a locale. According to some embodiments, the signal collector can implement a machine learning program to determine which signals to collect and updates the list of collected signals according to the determination.

Embodiments consistent with the present disclosure include a system comprising one or more processors and one or more storage devices storing instructions that when executed by one or more processors, cause the processor to: receive, from a web browser executed on a consumer electronic device and by a server executing an application, a request to perform a threat analysis of an access attempt; collect, through a signal collector of the application, a signal from a browser, a signal from the consumer electronic device, a signal from a network, and an interaction signal; aggregate, through an aggregator of the application, the collected signals into a database; parse, through a parser of the application, the collected signals; generate, through a signature generator of the application, a behavior signature from the collected signals; analyze, through an analyzer of the application, the behavior signature; determine, through the analyzer of the application, whether the access attempt is malicious based on the analysis; and implement, through a responder of the application, a security response on the web browser based on the access attempt being determined as malicious.

According to some embodiments, analyzing can further comprise generating a risk score and comparing the risk score to a threshold. According to some embodiments, the analyzer can implement a machine learning program to determine the risk score based on a database of previous access attempts. According to some embodiments, the interaction signal can comprise one or more of a mouse movement, a keyboard movement, a scroll, and a field entry. According to some embodiments, the network signal can comprise one or more of a browser header, a network property, and a network time offset. According to some embodiments, the device signal can comprise one or more of a pixel depth, a screen size, a color support, a processer property, a time zone, a graphic rendering application programming interface, and a locale. According to some embodiments, the signal collector can implement a machine learning program to determine which signals to collect and updates the list of collected signals according to the determination.

Embodiments consistent with the present disclosure include a computer processing system comprising: a memory configured to store instructions; and a hardware processor operatively coupled to the memory for executing the instructions to: receiving, from a web browser executed on a consumer electronic device and by a server executing an application, a request to perform a threat analysis of an access attempt; collecting, through a signal collector of the application, a signal from a browser, a signal from the consumer electronic device, a signal from a network, and an interaction signal; aggregating, through an aggregator of the application, the collected signals into a database, parsing, through a parser of the application, the collected signals; generating, through a signature generator of the application, a behavior signature from the collected signals; analyzing, through an analyzer of the application, the behavior signature; determining, through the analyzer of the application, whether the access attempt is malicious based on the analysis; and implementing, through a responder of the application, a security response on the web browser based on the access attempt being determined as malicious.

According to some embodiments, analyzing can further comprise generating a risk score and comparing the risk score to a threshold. According to some embodiments, the analyzer can implement a machine learning program to determine the risk score based on a database of previous access attempts. According to some embodiments, the interaction signal can comprise one or more of a mouse movement, a keyboard movement, a scroll, and a field entry. According to some embodiments, the network signal can comprise one or more of a browser header, a network property, and a network time offset. According to some embodiments, the device signal can comprise one or more of a pixel depth, a screen size, a color support, a processer property, a time zone, a graphic rendering application programming interface, and a locale.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for internet connected device identity and security according to an embodiment.

FIG. 2 illustrates a system for internet connected device identity and security according to an embodiment.

FIG. 3 illustrates a process diagram for internet connected device identity and security according to an embodiment.

FIG. 4 illustrates a sequence diagram for internet connected device identity and security according to an embodiment.

FIG. 5 illustrates a sequence diagram for internet connected device identity and security according to an embodiment.

### DETAILED DESCRIPTION OF PREFERRED EMBODIMENTS

Embodiments relate generally to systems and methods for internet connected device identity and security.

Embodiments may include combining data from multiple sources to generate a unified signature that identifies good behavior apart from malicious intent, which may be indicative of a bad actor on a browser and/or a mobile device, to help mitigate and/or eliminate malicious attempts from bad bots. Bad bots can be associated with denial-of-service attacks, data scraping, malicious use of resources, credential theft, session hijacking, spamming, account takeovers. These malicious uses can tax server resources including power, bandwidth, processing speed, and so on. Embodiments that combat these malicious uses can include risk scoring that compares a generated signature to known bot attempts and heuristic pattern analysis. Embodiments can identify a bot attempt uniquely and enable a binary decision matrix that can be used to determine a response to the bot. Embodiments can also generate a bot risk score output which can be implemented by consumers for further responses.

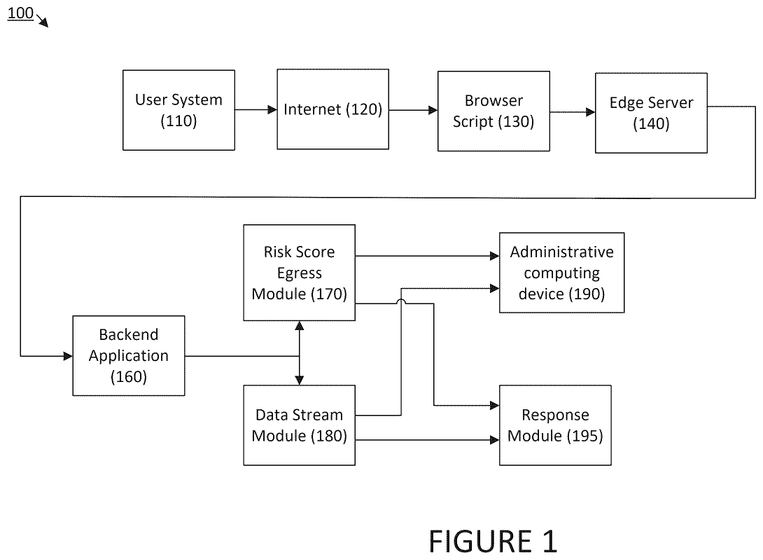

Referring to FIG. 1, a system diagram of an internet connected device identity and security system 100 is illustrated according to some embodiments.

Although directional arrows of identity and security system 100 generally illustrate a flow of data or information in one direction, reference will occasionally be made to how data or information may flow in the opposite direction. Illustration of the flow of data in the opposite direction of the arrows is omitted for clarity.

The internet connected device identity and security system 100 may include a user system 110 such as an end-user device (e.g., computer, mobile phone) that may initiate requests and interactions. For example, user system 110 can use a web browser application to interact with a website hosted by one or more servers. In some cases, a user may be a bot.

User system 110 may be configured to transmit a user's requests to an edge server 140 through a first communication channel such as the Internet 120.

Edge server 140 may be a delivery edge service (such as a content delivery network (CDN) or similar solution) where a lightweight application may run constantly with multiple patterns and variances of the file ready to be loaded onto user system 110 depending on the inherent logic embedded in the data encryption standard (DES) application and the parameters that were received from the front-end's request.

Edge server 140 may provide browser script 130 as part of a browser for user requests from the user system 110 through the Internet 120. The browser script 130 may be put into an obfuscated format (e.g., encrypted, hashed) by edge server 140 so that the user system 110 cannot determine how the browser script 130 functions, what encryption is used, or how to circumvent bot identification and detection.

In some embodiments, an organization network (not shown) may be an internal network infrastructure of the organization that houses various servers and browser services or applications hosted by the various servers. In some embodiments, an organization network may be coupled to a firewall (not shown) that may be a security barrier to protect usage of one or more web pages or internal networks of the organization network by one or more user devices associated with user systems 110 by monitoring and controlling incoming and outgoing network traffic passing through edge server 140. The firewall may filter out malicious traffic and potential threats before they reach a load balancer (not shown) associated with the browser script 130. In some embodiments, the firewall may be a hardened shell that protects internal code of an application or script operating as part of a browser script 130. The firewall may be positioned before the load balancer so that load balancer does not attempt to balance loads by malicious users or bots.

The load balancer may balance a load by distributing incoming network traffic (i.e., the load) that passes through the firewall to reach browser script 130, which may be hosted by multiple servers, to ensure no single server hosting browser script 130 becomes overwhelmed and/or slows service functionality such as uploading or downloading. The load balancer may enhance the availability and reliability of the browser script 130 by balancing the load.

Backend application 160 may be an application operated in conjunction with and support of browser script 130. Backend application 160 may process incoming traffic and analyze the traffic for bot activities and/or generate threat intelligence based on behavior. Backend application 160 may communicate with various components such a risk score egress module 170 and a data stream module 180 to manage and mitigate threats.

Risk score egress module 170 may be configured to generate and send risk scores based on the analysis performed by the backend application 160. These risk scores may be used to identify and block potential bot threats. The risk scores may be sent to an administrative computing device 190 for further action and/or decisions made based on the risk scores to allow or reject bot traffic, the decisions being implemented into browsers for similar traffic in the future. The risk scores may be sent to administrative computing device 190 for further action and/or decisions can be made based on the risk scores that are then implemented into browser systems.

Administrative computing device 190 may be an electronic device and/or application that may be an endpoint that receives processed data and risk scores from the risk score egress module 170 and data from data stream module 180. Administrative computing device 190 may be associated with an administrator of a web page or application. An interface of administrative computing device 190 (e.g., through a browser, or application connected to the browser) can be used with the provided information to take appropriate actions, such as blocking bot threats or allowing legitimate traffic. Administrative computing device 190 may represent the end-users or client systems that benefit from the malicious action protection provided by disclosed embodiments and systems.

Data stream module 180 may manage the flow of data within the system for further processing and storage. Data stream module 180 may decrypt the encrypted data received from backend application 160. In some embodiments, data stream module 180 may receive determinations of anomalies, risk scores, and/or bot identifications from backend application 160, and format a report for an administrator (e.g., administrative computing device 190) or responder (e.g., response module 195) to process the determinations. The data stream can ensure that relevant data is sent to the appropriate components for analysis and decision-making. Data stream module 180 may receive signals from backend application 160 and select signals based on highest risk score from risk score egress module 170 to send to response module 195. In some embodiments, data stream module 180 may pair risk scores with signals for decision-making (e.g., denial of access to the browser, allowance of traffic to the browser) by administrative computing device 190.

Response module 195 may be an endpoint that receives processed data and risk scores from the risk score egress module 170 and data from data stream module 180. Response module 195 may be configured to take certain actions in response to detecting bot based on modules 170, 180. For example, response module 195 may reject access to the browser based on detection of a malicious bot or allowing legitimate traffic. The response module 195 may initiate an automatic response including rejecting traffic if a risk score associated with an access attempt is above a threshold or allowing traffic if a risk score associated with an access attempt is below the threshold. In some embodiments, the response module 195 may use one or more rules or thresholds to determine and implement an appropriate response (e.g., deny access, allow access, request verification that a user is a human) based on the risk score from the risk score egress module 170.

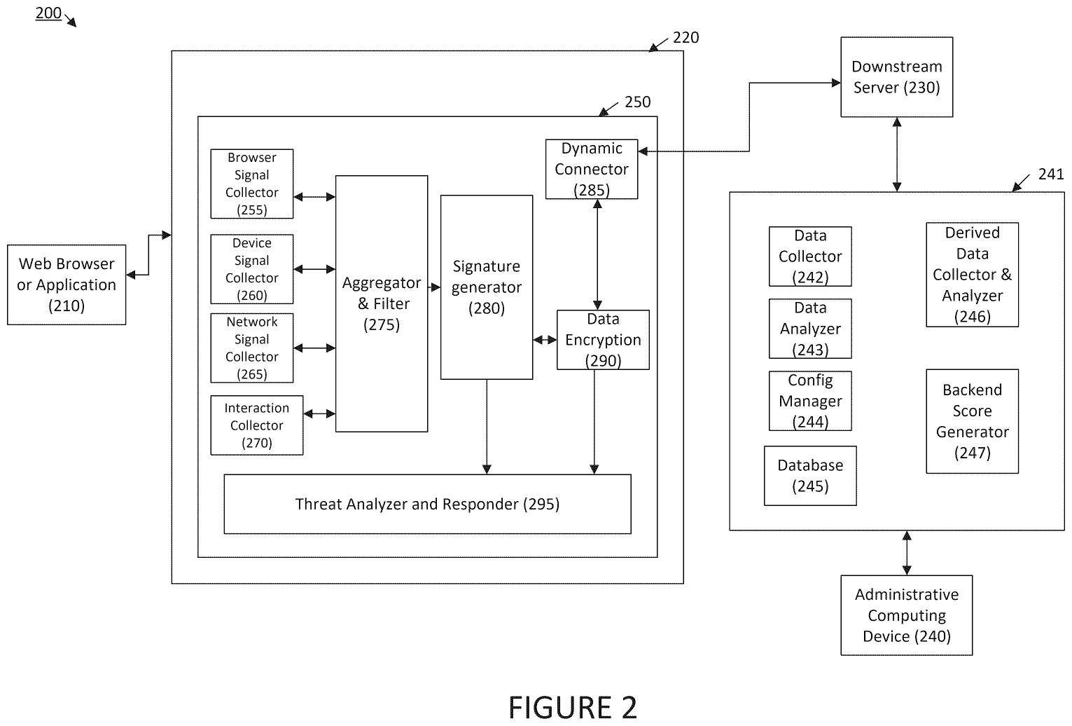

Referring to FIG. 2, a system diagram of an internet connected device identity and security system 200 is illustrated according to some embodiments.

The internet connected device identity and security system 200 may include a web browser or application 210. Web browser or application 210 may be a browser accessed by an end-user device (e.g., computer, mobile phone) that initiates requests and interactions. For example, web browser or application 210 may be used by a user device to access and/or interact with a website hosted by one or more servers.

Browser script 220 may be an application, file, script, or code that is operated in conjunction with, or as an embedding within, web browser or application 210. In some embodiments, browser script 220 may be a Javascript file. The Browser script 220 may include hardened shell 250.

Hardened shell 250 may be a hardened and obfuscated application/browser instructions that ensures no reverse engineering of the browser script 220 would be possible. Browser script 220 may include components of an identity and security application within hardened shell 250 that respond to an access attempt by a user device. Hardened shell 250 may include a number of collectors 255, 260, 265, and 270 that are each configured to collect certain information based on the access. Collectors 255, 260, 265, and 270 may be a set of instructions included in application/browser instructions (e.g., a Javascript file) that are used to generate the browser or the application for users. Further, should any bad actors identify the contents of the application/browser instructions, the application/browser instructions of browser script 220 could be dynamically changed.

Browser signal collector 255 may be configured to collect a signal that relates to a web browser or application 210 used by a user device in its access. The signal from the browser may include properties of the browser, time spent on the page, switches, refresh rate and more, generating a browser hash based on these properties.

Device signal collector 260 may be configured to collect a signal from a device used by web browser or application 210 in its access. The signal from the device may include pixel depth, screen size, color support, processor properties, WebGL, time zone/locale and more which is used to generate a unique device identity enabling identifying returning bad actors.

Network signal collector 265 may be configured to collect a signal from a device used by web browser or application 210 in its access. The signal from the device may include collecting the various HTTP and networking signals including browser headers, network properties, network time offset which do not generate a signature by itself but is used as a comparative data set for the other signatures to identify the validity of the other collected signals.

Interaction collector 270 may be configured to collect a number of inputs by web browser or application 210 in its access. For example, interaction collector 270 can collect a mouse movement, a mouse click, a keyboard stroke, a type of mouse click, or a scroll instruction, involving the browser or a website or an interaction with a script or code of a website or the browser.

Moreover, the interaction collector 270 may utilize a dynamic learning pattern that self-enhances over time using a backend application machine learning (ML) model that progressively enriches the way the interaction collector 270 identifies possible interactions with the browser/website, how customers interact with the browser/website, and how bots interact with the browser/website. The dynamic learning pattern using the ML model may take a standard set of possible interactions (e.g., from user, developer, or administrator testing) and compare the standard set against a new interaction to identify potential bot interactions. The ML model may update the interaction collector 270 to collect activities that align with bot or malicious use as compared to legitimate or human user use.

The aggregator and signal filter 275 may receive data from collectors 255, 260, 265, and 270 and provide aggregated and/or filtered data to a signature generator 280 that generates a signature based on behavior and/or the user device/system. Aggregator and signal filter 275 may be a component in the JavaScript file of the website/browser that aggregates the signals from collectors 255, 260, 265, 270 and parses them into machine readable format respectively. Aggregator and signal filter 275 may prioritize the collector signals based on a dynamic detection method which changes based on the location, time, customer, and other parameters. This component formalizes and standardizes the signals collected.

The dynamic detection method of the aggregator and signal filter 275 may be used to identify anomalies in the environment or behavior. Historically, attack vectors follow a certain pattern, i.e., patterns in browser agents used for attacks, patterns in time of the day or origin location of attacks, and/or patterns in operating systems (OS) that support such attacks. The dynamic detection method may include receiving the signal collection from collectors 255, 260, 265, and 270, performing anomaly detection on the collected signals, performing signal validation, and identifying risk factors associated with the collected signals.

In some embodiments, the dynamic detection method is used to identify anomalies in the signals and then run them through validations to check if they could have been spoofed. This method contributes to the bot decision/risk scoring mechanism.

In some embodiments, the dynamic detection method, as part of aggregator and filter 275, may identify if an Operating System (“OS”) is used by the accessing user device where the OS is not commonly used, if a browser agent is used by the accessing user device where the OS is uncommon, or if the collected signals indicate an insecure browser environment (e.g., strained connection). When anomalies are identified, an additional validation step is initialized by collecting extra signals. For example, each browser provides a unique result when the value of Pi is calculated using the Leibniz formula. This result shows if the identified browser agent signal corresponds to known results for that browser agent and if not then that gives an indication of a spoofed browser agent. This data is used to identify if the website is being opened in an incognito mode, within a webview, or from a deprecated browser.

Signature generator 280 may generate a signature that is provided to the threat analyzer and responder 295. Signature generator 280 may also provide the signature to data encryptor 290 so that any user cannot determine, based on any readable browser output, the determinations of the signature generator 280 or the threat analyzer and responder 295.

The signature generated by signature generator 280 may be an invisible two-dimensional canvas on screen which combines text, colors, borders, fonts, pixels, depth, browser, and system features including fonts, browser hash, time on page, WebGL, time zone & locale, browser plugins, http values and more. As a result, generating a signature that has a probability of 1:2,000,000 collective uniqueness.

The signature can be a combination of three different fingerprints generated during runtime. The fingerprints can be combined into an alphanumeric or character string. One fingerprint may be generated based on the user behavior, i.e., “Behavior fingerprint” which namely identifies click, mouse, copy paste, and other interactive signals generated by interaction collector 270 including user interactions with the browser. Including derived signals which may not be directly generated by the user but as a result of user interactions with the particular website. As an example, the web page opens a tab due to a certain user click. This also ensures that bots generating repetitive user behavior signals are caught within the disclosed tool as they tend to generate the repetitive patterns of movements and clicks.

The second fingerprint may be the device fingerprint from device signal collector 260 which is a hash generated from the signals collected by the device signal collector.

The third fingerprint may be a hash from the browser signal collector 255 combined with an invisible two-dimensional canvas on screen which combines text, colors, borders, fonts, pixels, depth, etc.

A combination of these signals ensures that the uniqueness of the final signature generated is tailored to the specific use case where the present application is integrated. But, the signature can be reliably generated from the same method for producing the signature based on the same original data. In a fraud detection use case, it may be important to ensure the uniqueness is maximized to be able to identify the user/bot uniquely, and hence the signals may be prioritized to collect the particular identification patterns from the above signals and a signature is generated guaranteeing a 1:2,000,000 uniqueness (i.e., only 1 in 2 Million users would be able to generate the exact same signature) which enables a reduction of false positives.

Signature generator 280 may generate the signature from the three fingerprints. In some embodiments, the output of signature generator 280 may include two unique signatures, for example, one generated from the device signals and another one from the behavior signals.

Data encryptor 290 may be configured to encrypt the signatures generated, the raw parsed data, and the threat score beyond recognition. The method for encrypting follows a two-pronged approach where the data is first obfuscated and then encrypted using an advanced encryption standard (“AES”) based technique which ensures the output generated comes out protected even before it is sent downstream (e.g., to dynamic connector 285).

Dynamic connector 285 is a two-part component with half the logic and algorithm residing inside browser script 220 and the other half residing on the edge server/downstream server 230 on the backend. The primary duty of this connector is to ensure that the analytics tool, its methods, and the obfuscation techniques used in browser script 220 may be dynamically updated based on the session. The downstream server 230 may process the encrypted data received from the dynamic connector 285 and send the processed data to an administrative computing device 240. During processing, downstream server 230 may compare the decoded signals as a group (e.g., considering all signals) to analyze sync and pattern (i.e., a certain version of a plugin is identified but the browser is not compatible with the publicly available plugin version). Patterns may be used by a pattern analyzer to compare to future attempts and/or learn signals to prioritize an order of signals to analyze or a weight of signals, consistent with disclosed embodiments.

Browser script 220 may enable malicious user/optimal bot identification, prediction and future malicious user and/or bot risk mitigation, aiming for elimination of attacks completely. Unlike known methods that look for identifying and differentiating between sessions and their primary intent is user tracking, identity and security system 200 may be configured to track actions of bots instead of humans. Thus, instead of tracking user behavior, identity and security system 200 may be configured to fingerprint connecting devices, systems, and actions, leading to identification of bots themselves. Thus, signals that are maliciously-related and/or bot associated may be identified.

Browser script 220 may be part of a browser (e.g., embedded) so that the browser script 220 may be configured to incorporate allowing for a threat analysis and response right on the browser hence avoiding the need for the packet to travel down a network and disruptively utilizing organizational network resources which could otherwise be utilized, for example, to enhance a user experience. The threat analyzer and responder 295 of browser script 220 may be configured to generate a risk score (e.g., through a risk score egress module 170) based on the signatures generated by signature generator 280 and validations made thereafter using the parameters from network signal collector 265 and interaction collector 270. Signals from collectors 255, 260, 265, 270 may be stored on a database (not shown) of a server for reference by threat analyzer and responder 295. Threat analyzer and responder 295 may also be configured to determine a response to a malicious access attempt or bot detection by performing a security response consistent with the present disclosure (e.g., allowing access, denying access, requiring validation). In some embodiments, threat analyzer and response module 195 may implement the security response by providing a signal to deny or allow access to web browser or application 210 sending instructions to communicate through the user's device.

Containers 241 may be part of a backend application or program executed by one or more processors on a backend server. Containers 241 may include components that aid, process, and output the scores that can be utilized by the customer for a unified identity solution or a bot protection solution. The components of the diagram are described below. For example, containers 241 may store data and track trends of collect information based on attempts by users to access web browser or application 210. Containers 241 may include independent containers, or modules, that may run in a scalable architecture but within the same secure environment to increase security. In some embodiments, containers 241 could be stored on one or more memories across one or more computing devices or within the same memory of a computing device.

Data collector 242 may be an adapter to collect information from the frontend application of browser script 220, decrypt the data, standardize the information, and make this data available for the other components to utilize.

Derived data collector and analyzer 246 may be configured to analyze the collected signals and fingerprint data, and send the analyzed data to the configuration manager 244 for storing and future reference. Data analyzer 243 may also be configured to forward the collected data to administrative computing device 240 and/or backend score generator 247 for device fingerprint analysis.

Configuration manager 244 may be a module that sends one or more configuration updates to threat analyzer and responder 295, aggregator and filter 275, signature generator 280, data analyzer 243, one or more collectors 255, 260, 265, 270, derived data collector and analyzer 246, backend score generator 247 when needed to update weights, prioritization of signal analysis, types of signals to be collected, baseline or typical patterns, etc. In some embodiments, configuration manager 244 may receive one or more rules from administrative computing device 240 to set a tolerance level (e.g., low, medium, high), a threshold level for a risk score, a type of response for one or more detected malicious bots or a type of detected malicious bots (e.g., a data scrapper, a malicious bot that spams entries into a form or user interface, or a bot that attempts to fraudulently access an account associated with an administrator), or any other rule to adjust configurations of one or more modules consistent with disclosed embodiments.

Database 245 may be a memory of a computer, server, or online network. In some embodiments, database 245 may perform calls to update information of connected devices and/or browsers. For example, database 245 may communicate with a user's device to acquire and check for device recognition information using the device fingerprint. The device recognition information may be stored on database 245 for reference (e.g., when checking device information against a previous access attempt).

Derived data collector and analyzer 246 may be an intermediary for receiving the organizational data for device fingerprint analysis (i.e., data already present within the organization or consumer database which may have additional analysis of a fingerprint), which may enhance organizational knowledge. For example, derived data collector and analyzer 246 may average collector signals so that the average can be compared to received signals to determine outliers. Derived data collector and analyzer 246 may perform an analysis on collected signals across multiple devices to determine weights, priority, or configuration updates, consistent with disclosed embodiments.

Backend score generator 247 may be configured to generate a backend score based on the signals and fingerprint information. The backend score can be generated through artificial intelligence or through machine cleaning, consistent with disclosed embodiments. Backend score generator 247 may send the generated bot score to the database 245.

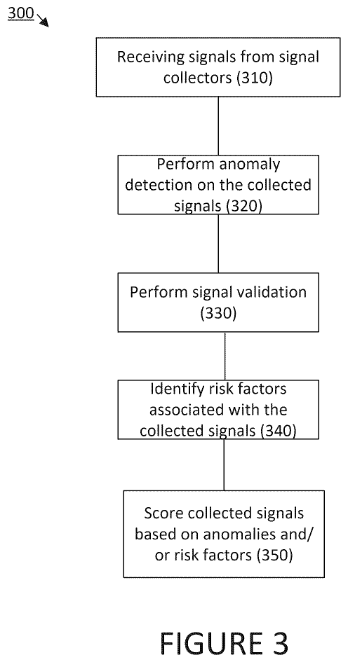

Referring to FIG. 3, a process diagram of an internet connected device identity and security method 300 is illustrated according to some embodiments.

A dynamic detection method may be used by one or more components of an internet connected device identity and security system such as aggregator & signal filter.

At step 310, the internet connected device identity and security system may include receiving the signal collection from one or more collectors (e.g., collectors 255, 260, 265, and 270).

At step 320, the internet connected device identity and security system may perform anomaly detection on the collected signals. Anomaly detection may be performed by detecting differences when comparing a signal to an average, a weighted average, a density, or a pattern of signals.

At step 330, the internet connected device identity and security system may perform signal validation. In some embodiments, the signal validation may be performed by comparing one or more signatures (e.g., from signature generator 280) to one or more signals from signal collectors (e.g., from collectors 255, 260, 265, 270). The signature may indicate the browser, device, and/or network, and thus the currently used browser, device, and/or network can be detected when validating to ensure the same device, browser, and/or network combination is being used to access the application or web browser.

At step 340, the internet connected device identity and security system may identify risk factors associated with the collected signals. Risk factors may be based on a location of access, a source of access (e.g., a webpage requesting access), a date or time, or a comparison of an access attempt to a historic signal analysis or a baseline.

At step 350, the internet connected device identity and security system may score collected signals based on detected anomalies and/or risk factors. In some embodiments, the scores may be weighted based on a comparison of past factors.

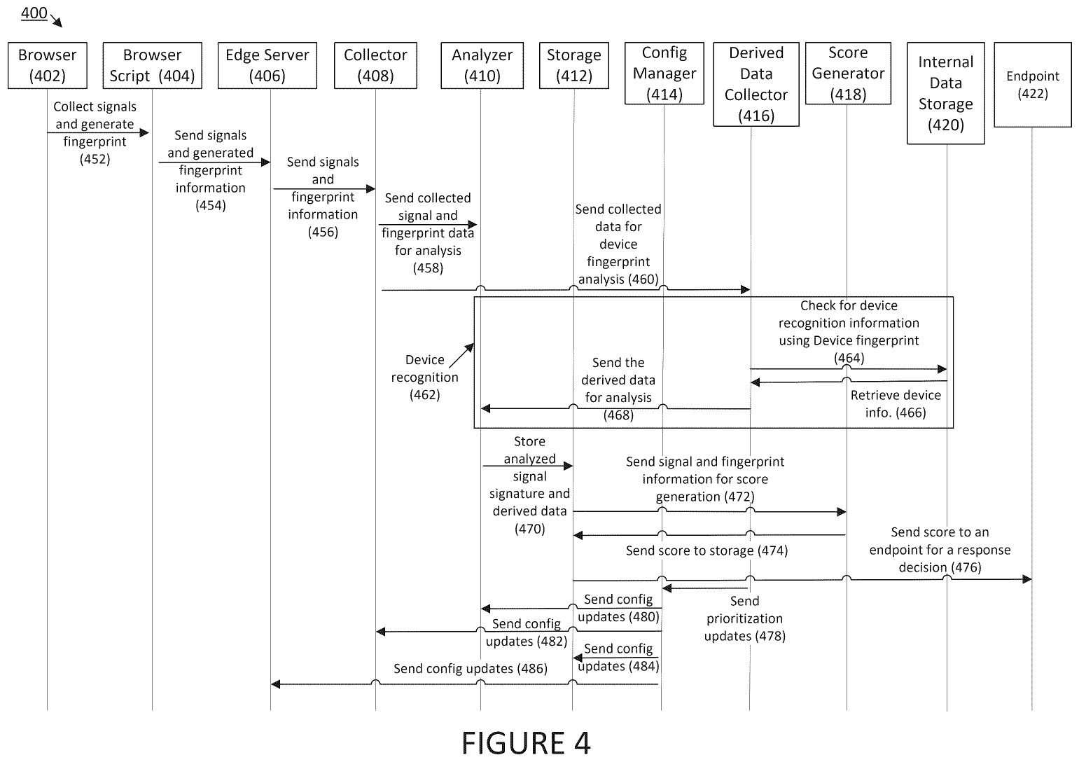

Referring to FIG. 4, a sequence diagram of an identity and security system 400 is illustrated according to some embodiments. In particular, FIG. 4 illustrates interactions between devices and components of identity and security system 400.

In step 452, browser 402 of a user-facing system may be used by an external device. In response, browser 402 may initiate a request to access a browser or application.

In step 454, signals may be generated resulting from the access of browser 402 by browser script 404 installed on or as a part of an application or browser and sent to edge server 406. Browser script 404 may be installed as part of a Javascript file of a browser. Browser script 404 may generate fingerprint information from a device, an interaction, and/or a browser, as discussed above.

In step 456, edge server 406 may forward the signals and generate fingerprint information to collector 408. Collector 408 may be a data collector inside a backend application. Edge server 406 may include an encryption or firewall where all the individual components of the backend application can run as independent containers in a scalable architecture but within one secure environment for maximum security, inaccessible directly from users. Collector 408 may collect information from the front end, decrypt the data, standardize the information, and make this data available for the other components.

In step 458, collector 408 may send the collected data to the analyzer 410 for analysis. Analyzer 410 may analyze the collected signals and fingerprint data, consistent with disclosed embodiments.

In step 460, collector 408 may send collected data for device fingerprint analysis to a derived data collector 416. Derived data collector 416 may be an intermediary for receiving signals and comparing it to stored device fingerprint analysis (i.e., data already present within the organization or consumer database which may have additional analysis of the fingerprint). In some embodiments, derived data collector 416 may be omitted from identity and security system 400, in which case steps 460, 464, 466, and 468 may also be omitted.

The comparison may be done through a hash table of information stored in the backend appliance that is constantly updated through various online sources of system, device, browser, plugin and hardware information and compatibilities. The table can be created by, first, the database (e.g., storage 412 or another database (not shown)) storing information in the form of a non-structures data set including the signals collected and the signatures generated. Next, each entry (e.g., field entry) in the table is assigned a unique identification (UUID) which identifies each API request executed. Then, the associated signals are stored in a long string format. All the data stored in the database is in obfuscated form (e.g., encrypted).

Device recognition step 462 may include several sub-steps, including steps 464, 466, and 468. In step 464, derived data collector 416 may request stored device fingerprint information from internal data storage 420 to compare the stored device fingerprint information in a database of device information in internal data storage 420 with the acquired device information from collector 408 in order to determine if the device connected to browser 402 is known/recognized. Derived data collector 416 may aggregate signals from collectors 408 and parse the aggregated signals into machine readable format respectively. Derived data collector 416 may prioritize the collector signals based on a dynamic detection method which changes based on the location, time, customer, and other parameters. Derived data collector 416 may further be configured to formalize and standardize the signals collected.

In step 466, device information may be returned from internal data storage 420 to derived data collector 416 for the comparison.

In step 468, the derived data, including the comparison, from derived data collector 416 may be sent to analyzer 410. Analyzer 410 may make a determination if the accessing device, browser, and/or interaction signals, including the comparison, are consistent with a bot or malicious attack.

In step 470, analyzer 410 may send the analyzed data and/or signals and comparison to the storage 412 for storing and for future reference. Storage 412 may be used for analyzed signals and derived data as well as the configuration and configuration updates. Storage 412 may be a memory accessible by the network as part of a computer, server, or network.

In step 472, score generator 418 may retrieve signal and fingerprint information for score generation from storage 412. Score generator 418 may be an artificial intelligence or machine learning model trained to generate score by processing derived data from the derived data collector 416. Score generator 418 may generate a score using one or more of the following steps:

1. Data collection and preprocessing (as discussed earlier) may ensure the collected metrics are cleaned and preprocessed; and normalize the data to bring metrics to a comparable scale.

2. Feature Weighting where disclosed systems may assign weights to each signal based on its importance in identifying malicious behavior. This is determined through: expert knowledge and domain expertise; statistical analysis to identify the most risk-prone signals; and/or machine learning techniques such as from tree-based models (e.g., Random Forest).

3. Scoring which can be by a linear combination scoring methodology, for example where a risk score is equal to (Weight1× Metric1)+ (Weight2×Metric2)+ (Weight3×Metric3)+ (WeightN× MetricN).

The factors determining the fraud risk is largely within the signals and the way the signals are interpreted, e.g., by analyzer 410. This dataset can be utilized for enhanced analysis and AI/ML-based detection which can identify key differentiators between good and malicious behavior (e.g., timing, patterns, location, associated software or equipment, clicks, entries) and to set weights associated with each behavior.

4. A threshold determination by disclosed systems may include determining thresholds for categorizing the risk score into different risk levels (e.g., low, medium, high). Historical data can then be used to set thresholds by analyzing the distribution of scores for known good and bad behaviors. For example, if a risk score<0.3, then a risk level may be “Low Risk”; if a risk score<0.6, then a risk level is “Medium Risk”; and if a risk score≥0.6, then a risk level is “High Risk”. More or less risk levels are contemplated.

5. Model evaluation and adjustment by disclosed systems including at regular intervals. For example, disclosed systems may evaluate the algorithm's performance using metrics like precision, recall, harmonic mean of the precision and recall (e.g., F1 score), and Receiving Operating Characteristic (ROC)/aera under the ROC curve (AUC). In some embodiments, over time, the system can adjust the weights and thresholds based on the evaluation results.

In step 474, score generator 418 may send the generated score to storage 412.

In step 476, internal data storage 420 may send the generated score to endpoint 422 for a response decision. Endpoint 422 may be a consumer appliance or automatic response system that may use the generated score for final decision-making. The endpoint 422 may either allow, mitigate, block, or require further validation such as escalate to Captcha or human validation solutions based on the generated score. In some embodiments, human validation solutions may include requiring an answer to a phone call, text message, or e-mail.

In step 478, configuration manager 414 may receive prioritization updates from derived data collector 416 where the prioritization updates include which signals from collectors 408 to prioritize in its analysis. For example, prioritization updates may include prioritization of mouse signals over keyboard signals based on historical analysis and machine learning. Configuration manager 414 (similar to configuration manager 244) may be a module that manages configurations used by one or more modules for consistency across multiple uses of a browser script 404, and that can update configurations consistent with disclose embodiments.

In step 480, configuration manager 414 may provide configuration updates to analyzer 410. For example, configuration updates for analyzer 410 may include prioritization updates of which signals to prioritize when analyzing, updating weights of signals, or any other updates consistent with disclosed embodiments.

In step 482, configuration manager 414 may provide configuration updates to collector 408. For example, configuration updates for collector 408 may include updates to which signals to collect, or any other updates consistent with disclosed embodiments.

In step 484, configuration manager 414 may provide configuration updates to storage 412 for reference. One or more modules may pull updates from storage 412. In some embodiments, configuration manager 414 may replace an older configuration instruction with a new configuration instruction.

In step 486, configuration manager 414 may provide configuration updates to edge server 406. For example, configuration updates to edge server 406 may include changing an encryption technique so that a user cannot access a backend application (e.g., backend application 160).

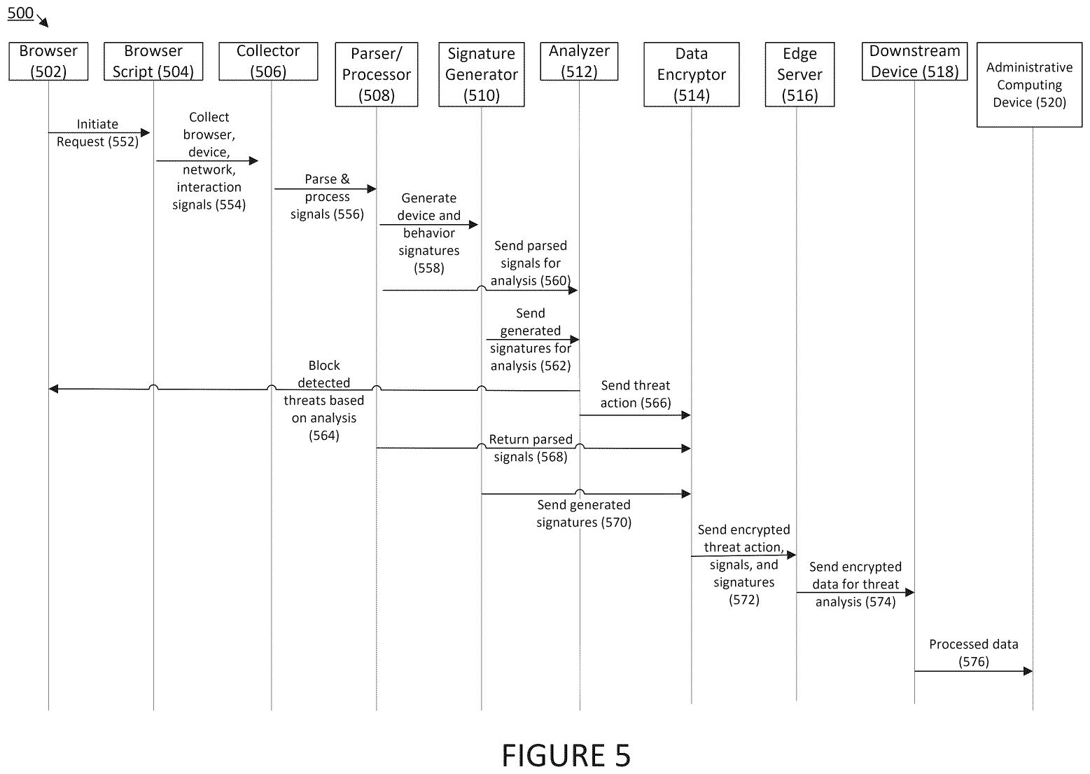

Referring to FIG. 5, a sequence diagram of an identity and security system 500 is illustrated according to some embodiments. In particular, FIG. 5 illustrates interactions between the various components inside the file and how data flows within an identity and security application that executes on the user's system.

In step 552, a browser 502 or a user interface can initiate a request from a browser script 504 which starts the process, and/or detects threats and blocks amateur bot threats based on primary threat analysis. Browser script 504 may be a software component embedded in a user interface such as a web browser that initiates the request and interacts with the collector 506. Browser script 504 may be a browser script, plug-in, add-on, or other code that automatically executes when a web page or user application is accessed. Browser script 504 may execute and make a bot detection before one or more resources of the web page or user application are accessed. Browser script 504 may respond to the use of browser 502 by one or more bots/users. Browser script 504 may be provided to one or more connecting devices as executed on an edge server or another server or backend.

In step 554, collector 506 may collect various signals from the browser, device, network, and user interactions through browser script 504. The signals may include browser or user agent details. The browser or user agent details may include a browser type, operating system, and/or IP address. The signals may include a screen resolution, a locale (e.g., city, state, province, country, geographical area), and/or plugins such as plugins installed on a browser. The signals can include mouse movements (e.g., a set number of movements, movements over a period of time), page scrolls, typing speed, a copy-paste event, a URL page where the disclosed application/system is being loaded (e.g., captured from HTTP headers), a time spent on a page, a click location (e.g., a set number of clicks or all clicks), a pixel depth (e.g., in bits per pixel), a color depth (e.g., a number of colors that can be displayed in bit-color), a window/viewport width and/or height, a mouse wheel event, a diagonal size, a display aspect ratio, a time-zone, a cookie tracking, an extension on a browser, a font, a 2D and 3D graphic API report, a graphic rendering API, a battery state, a connected peripheral (e.g., formatted values of audio and video), a math processor, a screen refresh rate, a server date and/or time, a cache control, a content encoding, a content security policy, a content type, a trace id, a cross-site scripting protection value and/or parameter, an application information, a script, a domain reference, an autofill event, a number of iframes, a background property, a height and width offset, a security control, a device memory, a user agent proxy, a geolocation, a session history, an index database support, and a math machine learning support.

In step 556, parser & processor 508 may use the collected signals from collector 506 to generate device and behavior signatures. The parser may be configured to analyze the signals and then split the analyzed signals into logical syntactic components in order to examine them. For example, mouse signals may be retrieved from collectors 506 in the format of x, y where x and y are co-ordinates of the mouse pointer on the screen. However, the retrieved data may not be able to be utilized directly. Therefore, the mouse signals may be run through the parser which convert them into formats (e.g., x, y coordinates into integer values) that can be understood and analyzed.

In step 558, parser & processor 508 may send the generated signature(s) to signature generator 510 that may be configured to generate device and behavior signatures from the signals processed by the parser & processor 508.

In step 560, parser & processor 508 may send parsed signals for analysis to analyzer 512 for analysis in step 564.

In step 562, signature generator 510 may send the generated signatures to analyzer 512 for analysis in step 564.

In step 564, analyzer 512 (e.g., threat analyzer & responder) may analyze the parsed signals and generated signatures to identify potential threats and make determinations to block, allow, or take further action that are then returned to browser 502. The type of analysis and determination is further discussed above.

In some embodiments, analyzer 512 may send threat actions back to the parser & processor 508 to improve processes of the parser & processor as discussed above.

In step 566, analyzer 512 may send action, signals, and signatures to the data encryptor 514. Data encryptor 514 may encrypt the data, including primary threat actions, signals, and signatures. Data encryptor 514 may send the encrypted data to an edge server 516 and a downstream device 518 for further analysis using machine learning (ML). Data encryptor 514 may ensure that the data is secure during transmission.

In step 568, parsed signals may be passed by parser & processor 508 to data encryptor 514.

In step 570, generated signatures may be sent by signature generator 510 to data encryptor 514 for encryption.

In step 572, edge server 516 may receive encrypted data from the data encryptor 514. Edge server 516 may send the data to a downstream device 518 for threat analysis using ML as discussed above, and for further reference and refinement of configurations and prioritization, as discussed above.

In step 574, downstream device 518 may decrypt the encrypted data received from the edge server 516. In some embodiments, downstream device 518 may receive determinations of anomalies, risk scores, and/or bot identifications, and format a report for an administrator to process the determinations. Downstream device 518 may send the processed data to the administrative computing device 520, which may be an endpoint that receives the processed data.

In step 576, administrative computing device 520 may provide one or more rules that are used for final decision-making and action. For example, a rule may be based on a threshold risk score, risk level, or number of allowed accesses. Final decision making can include blocking only high-risk behavior or high and medium risk behavior. Or, any level of behavior can be responded to with a captcha or OTP access requirement. In some embodiments, if no action is taken in response to the requirement within a set time period, the access request may be denied.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory.

The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In some embodiments, the processing machine may be a specialized processor. In some embodiments, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for internet connected device identity and security, comprising:
receiving, from a web browser executed on a consumer electronic device and by a server executing an application, a request to perform a threat analysis of an access attempt;
collecting, through a signal collector of the application, a signal from a browser, a signal from the consumer electronic device, a signal from a network, and an interaction signal;
aggregating, through an aggregator of the application, the collected signals into a database,
parsing, through a parser of the application, the collected signals;
generating, through a signature generator of the application, a behavior signature from the collected signals;
analyzing, through an analyzer of the application, the behavior signature;
determining, through the analyzer of the application, whether the access attempt is malicious based on the analysis; and
implementing, through a responder of the application, a security response on the web browser based on the access attempt being determined as malicious.

2. The method of claim 1, wherein analyzing further comprises generating a risk score and comparing the risk score to a threshold.

3. The method of claim 2, wherein the analyzer implements a machine learning program to determine the risk score based on a database of previous access attempts.

4. The method of claim 1, wherein the interaction signal comprises one or more of a mouse movement, a keyboard movement, a scroll, and a field entry.

5. The method of claim 1, wherein the network signal comprises one or more of a browser header, a network property, and a network time offset.

6. The method of claim 1, wherein the device signal comprises one or more of a pixel depth, a screen size, a color support, a processer property, a time zone, a graphic rendering application programming interface, and a locale.

7. The method of claim 1, wherein the signal collector implements a machine learning program to determine which signals to collect and updates a list of signals to collect according to the determination.

8. A system comprising one or more processors and one or more storage devices storing instructions that when executed by one or more processors, cause the processor to:
receive, from a web browser executed on a consumer electronic device and by a server executing an application, a request to perform a threat analysis of an access attempt;
collect, through a signal collector of the application, a signal from a browser, a signal from the consumer electronic device, a signal from a network, and an interaction signal;
aggregate, through an aggregator of the application, the collected signals into a database,
parse, through a parser of the application, the collected signals;
generate, through a signature generator of the application, a behavior signature from the collected signals;
analyze, through an analyzer of the application, the behavior signature;
determine, through the analyzer of the application, whether the access attempt is malicious based on the analysis; and
implement, through a responder of the application, a security response on the web browser based on the access attempt being determined as malicious.

9. The system of claim 8, wherein analyzing further comprises generating a risk score and comparing the risk score to a threshold.

10. The system of claim 9, wherein the analyzer implements a machine learning program to determine the risk score based on a database of previous access attempts.

11. The system of claim 8, wherein the interaction signal comprises one or more of a mouse movement, a keyboard movement, a scroll, and a field entry.

12. The system of claim 8, wherein the network signal comprises one or more of a browser header, a network property, and a network time offset.

13. The system of claim 8, wherein the device signal comprises one or more of a pixel depth, a screen size, a color support, a processer property, a time zone, a graphic rendering application programming interface, and a locale.

14. The system of claim 8, wherein the signal collector implements a machine learning program to determine which signals to collect and updates a list of signals to collect according to the determination.

15. A non-transitory computer readable storage medium, including instructions stored thereon, which when read and executed by one or more computer processors, cause the one or more computer processors to perform steps comprising:
receiving, from a web browser executed on a consumer electronic device and by a server executing an application, a request to perform a threat analysis of an access attempt;
collecting, through a signal collector of the application, a signal from a browser, a signal from the consumer electronic device, a signal from a network, and an interaction signal;
aggregating, through an aggregator of the application, the collected signals into a database,
parsing, through a parser of the application, the collected signals;
generating, through a signature generator of the application, a behavior signature from the collected signals;
analyzing, through an analyzer of the application, the behavior signature;
determining, through the analyzer of the application, whether the access attempt is malicious based on the analysis; and
implementing, through a responder of the application, a security response on the web browser based on the access attempt being determined as malicious.

16. The non-transitory computer readable storage medium of claim 15, wherein analyzing further comprises generating a risk score and comparing the risk score to a threshold.

17. The non-transitory computer readable storage medium of claim 16, wherein the analyzer implements a machine learning program to determine the risk score based on a database of previous access attempts.

18. The non-transitory computer readable storage medium of claim 15, wherein the interaction signal comprises one or more of a mouse movement, a keyboard movement, a scroll, and a field entry.

19. The non-transitory computer readable storage medium of claim 15, wherein the network signal comprises one or more of a browser header, a network property, and a network time offset.

20. The non-transitory computer readable storage medium of claim 15, wherein the device signal comprises one or more of a pixel depth, a screen size, a color support, a processer property, a time zone, a graphic rendering application programming interface, and a locale.
